(19) United States
(12) Patent Application Publication
(10) Pub. No.: US 2025/0259537 A1
(43) Pub. Date: Aug. 14, 2025

(54) COOPERATIVE DETECTION SYSTEM AND METHOD FOR VEHICLES

(71) Applicant: FCA US LLC, Auburn Hills, MI (US)

(72) Inventors: Matthew J Mazurek, Rochester Hills, MI (US); Laurent Dizambourg, Gif sur Yvette (FR); Saleh Bensator, Puteaux (FR)

(21) Appl. No.: 18/441,037

(22) Filed: Feb. 14, 2024

(51) Int. Cl. G08G 1/01; G06V 20/58; G06V 20/62; G08G 1/04

(52) U.S. Cl. CPC G08G 1/0141; G06V 20/58; G06V 20/625; G08G 1/04; G06V 2201/08

(57) ABSTRACT

A cooperative detection system and method that detects a vehicle accident, determines if a non-connected vehicle was involved in the accident, receives accident information from at least one connected entity in the vicinity of the accident, combines the various pieces of accident information into an aggregated data set, and uses the aggregated data set to generate an accident report that includes information pertaining to the non-connected vehicle. The system and method may use cooperative perception messages (CPMs) to report the accident information from the connected vehicles to a cloud-based backend system. The accident report, which may include an accident timeline, can be useful to authorities investigating the accident, particularly when a non-connected vehicle is involved that lacks access to accident information collected by nearby connected entities, such as connected vehicles, connected infrastructure, connected pedestrians, etc.

### FIELD

The present disclosure relates to cooperative detection systems and methods for vehicles and, more particularly, to cooperative detection systems and methods where connected vehicles gather and provide information regarding non-connected vehicles that have been involved in an accident.

### BACKGROUND

When a vehicle accident occurs, there is typically a large amount of accident information that is available from nearby connected entities, such as connected vehicles, connected infrastructure, connected pedestrians, etc. Connected vehicles may have access to such accident information, whereas non-connected vehicles generally do not. If the vehicle accident involves a non-connected vehicle, it may be difficult for the authorities investigating the accident to have a complete understanding of the circumstances and events leading up to the accident, despite the fact that a large collection of relevant accident information and data exists that could aid in their investigation.

It is, therefore, an object of the present application to provide a system and method that gathers accident information from connected entities in the vicinity of a vehicle accident that involves a non-connected vehicle in order to sufficiently address and overcome the preceding drawback.

### SUMMARY

In at least some implementations, there is provided a cooperative detection method for use with vehicles, comprising the steps of: detecting a vehicle accident; determining that a non-connected vehicle was involved in the vehicle accident; receiving accident information from at least one connected entity in the vicinity of the vehicle accident; combining accident information into an aggregated data set; and using the aggregated data set to generate an accident report, wherein the accident report includes information pertaining to the non-connected vehicle.

In at least some implementations, there is also provided a cooperative detection system for use with vehicles, comprising: a plurality of connected vehicles, each of the connected vehicles is configured to detect a vehicle accident; and a cloud-based backend system, the cloud-based backend system is in wireless communication with the plurality of connected vehicles and is configured to: determine if a non-connected vehicle was involved in the vehicle accident detected by one of the connected vehicles, receive accident information from at least one connected entity in the vicinity of the vehicle accident; combine accident information into an aggregated data set; and use the aggregated data set to generate an accident report, wherein the accident report includes information pertaining to the non-connected vehicle.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is schematic view of an example of a connected vehicle that may be used with the cooperative detection system and method of the present application;

FIG. 2 is a schematic view of an example of the cooperative detection system of the present application, the system is illustrated in the context of an intersection where a vehicle accident has occurred; and

FIG. 3 is a flowchart of an example of the cooperative detection method of the present application.

### DETAILED DESCRIPTION

Referring in more detail to the drawings, there is shown a cooperative detection system and method involving one or more connected and non-connected vehicles. The term “connected vehicle,” as used herein, broadly includes any vehicle that can wirelessly communicate messages, information and/or other data with other connected entities (e.g., other connected vehicles, connected infrastructure, connected pedestrians, a cloud-based backend system, etc.) on a common authenticated network in order to gain a better situational awareness of the surrounding area. A non-limiting example of a “connected vehicle” is a 5G enabled vehicle that can send and/or receive cooperative perception messages (CPMs). The term “non-connected vehicle,” as used herein, includes any vehicle that is not a connected vehicle.

Consider the example where a vehicle accident has occurred involving a non-connected vehicle and the authorities are trying to recreate the accident scene. Traditionally, a non-connected vehicle may have access to internal hardware and sensors onboard the vehicle, but otherwise is limited in terms of external sensor and other data that may be helpful in reconstructing the details of the accident. This may be the case even when there is a wide variety of external sensor and other data available from nearby connected entities. The cooperative detection system and method described herein are designed to gather this external data from nearby connected vehicles, connected infrastructure and/or connected pedestrians and compile it into a report or other type of useful output that can help reconstruct the scene of the accident. One potential way of gathering such external information is with the use of cooperative perception messages (CPMs), which are standardized messages designed to distribute safety information between various vehicle-to-everything (V2X) vehicles. However, other standardized messages, services, networks, etc. may be used instead.

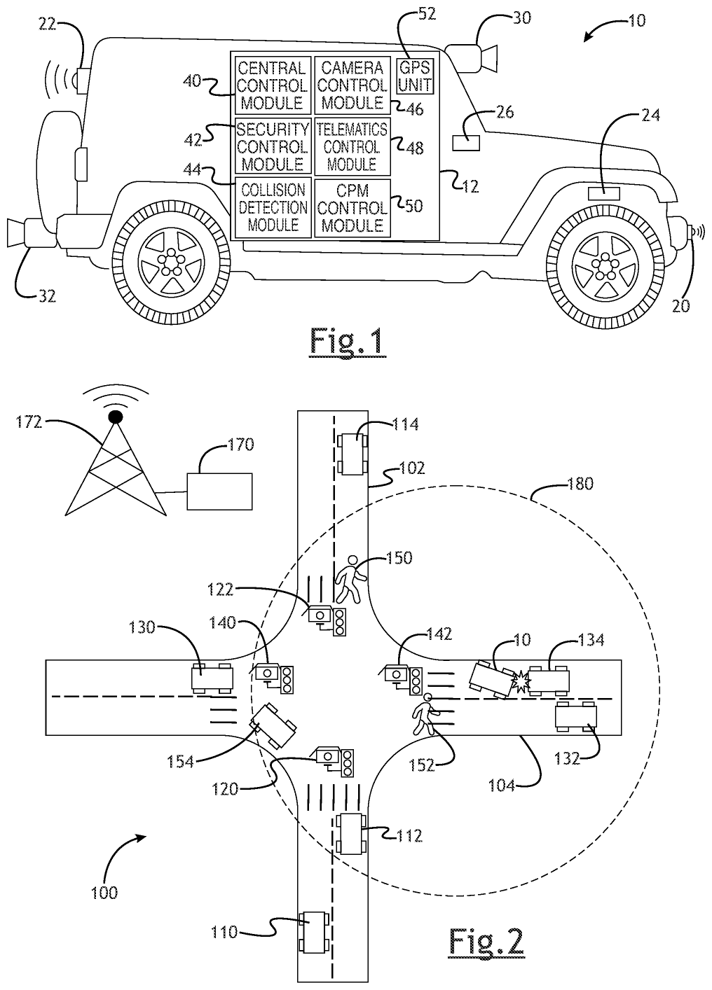

Turning now to FIG. 1, there is shown a non-limiting example of a connected vehicle 10 that can be used with the cooperative detection system and method described herein. Connected vehicle 10 may be any type of car, truck, sports utility vehicle (SUV), off road vehicle (ORV), cross over vehicle, commercial vehicle, etc., and it may be powered by a traditional internal combustion engine, one or more electric motor(s), or a hybrid arrangement of both, to cite a few possibilities. Connected vehicle 10 may include any suitable combination of electronic hardware 12, including various sensors 20-26, cameras 30-32, and modules and units 40-52, as described below. Skilled artisans will appreciate that other electronic hardware, in addition to hardware 12, will likely be included with connected vehicle 10 and that hardware 12 is simply provided for purposes of illustrating the cooperative detection systema and method.

Sensors 20 and 22 are mounted towards the front and rear, respectively, of connected vehicle 10 and gather various types of information and data from the surrounding environment. Sensors 20 and 22 may be object detection or proximity sensors, such as those that use cameras, lidar, radar or other types of electromagnetic and/or ultrasonic emissions to detect the presence and/or determine the proximity of nearby objects, whether they be stationary or moving. Only a single sensor 20 is illustrated on the front and on the rear of the connected vehicle, but additional sensors could certainly be added for short, medium and/or long range object detection, as well as for monitoring the sides of the vehicle. Sensor 24 is a vehicle speed sensor and may include one or more separate sensors mounted near the vehicle's gearbox, wheel axle, wheels, or some other suitable location. Sensor 26 is an airbag sensor and may include one or more sensors mounted near the passenger cabin for purposes of detecting airbag status and/or deployment. In at least some implementations, sensors 20-26 are connected to some combination of modules 40-52, including central control module 40, collision detection control module 44, telematics control module 48, CPM control module 50 and/or others.

Cameras 30 and 32 are similarly mounted towards the front and rear, respectively, of connected vehicle 10 and gather various types of images and data from the surrounding environment. Although cameras 30, 32 and sensors 20-26 are shown in FIG. 1 as separate devices, they may be integrated into combined units or devices. Some non-limiting examples of sensor technologies that may be used with cameras 30 and 32 include, but are not limited to, complementary metal oxide semiconductor (CMOS) and charge coupled device (CCD). Again, it is not necessary for connected vehicle 10 to specifically have one forward facing camera 30 and one rearward facing camera 32, as other types, combinations and/or numbers of cameras may be used instead (e.g., one or more side facing cameras may be provided). These cameras may be connected to any suitable combination of modules and units 40-52, including the collision detection control module 44, camera control module 46, CPM control module 50 and/or others.

Modules and units 40-52 are mounted on connected vehicle 10 and are configured to control or manage certain vehicle systems, subsystems and/or functions. Modern vehicles typically have a large and diverse collection of such electronic modules, the exact makeup of which depends on the nature and sophistication of the vehicle (e.g., a vehicle capable of autonomous driving will likely have more electronic modules than one without such a feature). Electronic modules, also referred to as electronic control units, electronic controllers or just controllers, have embedded software for carrying out their prescribed tasks or functions and are connected to numerous other electronic devices throughout the vehicle via some type of wired or wireless internal communications network (e.g., a vehicle bus). It should be noted that connected vehicle 10 may include any suitable combination or arrangement of electronic modules and/or communications networks and is not limited to the specific embodiments schematically illustrated in FIG. 1 or described herein.

Central control module 40, sometimes called a body control module (BCM), is configured to control or supervise certain control functions related to the vehicle body, such as door locks, windows, lights, etc. Security control module 42 is configured to manage certain control functions related to the security of the vehicle, like managing a vehicle alarm system and/or theft detection system. Collision detection control module 44, which may be part of a larger collision warning or avoidance system, is configured to monitor potential collisions and, if one is detected, then generate an appropriate warning. Detection of a potential collision oftentimes involves evaluating the speed of the driven vehicle, the speed of one or more target vehicle(s), and the relative distance(s) between such vehicles. Accordingly, collision detection control module 44 may be connected to sensors 20-26 and/or cameras 30-32. Camera control module 46 is configured to control certain control functions related to the various cameras located around the vehicle and to receive and/or process video and image feeds from such cameras. Thus, camera control module 46 may be connected to forward facing camera 30 and rearward facing camera 32. Telematics control module 48 is an embedded onboard system that is configured to control wireless tracking, diagnostics and/or communication to and from the connected vehicle 10. According to one example, the telematics control module 48 is 5G enabled so that connected vehicle 10 can connect to a 5G cellular network and send and/or receive cooperative perception messages (CPMs), in addition to other wireless communications. CPM control module 50 is configured to manage CPMs sent from the various vehicle sensors and cameras and to provide such CPMs (or other information derived from CPMs) to the telematics control module 48. Therefore, CPM control module 50 may be connected to sensors 20-26, cameras 30-32, and telematics control module 48. Global positioning system (GPS) unit 52, which may be part of a larger vehicle navigation system, is configured to use the Global Navigation Satellite System (GNSS) network in order to determine the location of the vehicle. More specifically, the GPS unit 52 receives signals from multiple GNSS satellites and then uses an algorithmic technique called trilateration to determine the precise location of the connected vehicle 10. The GPS unit 52 may be connected to any combination of modules 40-50.

It should be recognized that any of the “connections” disclosed herein may be direct connections (i.e., connections between two or more devices without intervening devices), indirect connections (i.e., connections between two or more devices with one or more intervening devices), or some other type of connection known in the art. For instance, any suitable combination of sensors 20-26, cameras 30-32, modules 40-52 and/or other electronic devices may be directly connected to one another or indirectly connected to one another via a vehicle bus or other communication network, even if not specifically listed above.

Turning now to FIG. 2, there is shown an example of an intersection 100 where the cooperative detection system 90 of the present application may be used. Intersection 100 is a classic example of a four leg intersection where first and second roads 102, 104 meet and cross one another at a perpendicular angle. Of course, the cooperative detection system and method are not limited to this particular intersection and may be used with any intersection, road, street, highway, freeway, parking lot and/or other area where vehicles are driven. According to this particular example, each of the first and second roads 102, 104 is a two lane road that allows for bidirectional traffic and has multiple vehicles on the road. The first road 102 has two driven vehicles 110 and 112 traveling in opposite directions, one stationary vehicle 114 that is parked, and two traffic lights with intersection cameras 120 and 122. The second road 104 has four driven vehicles 10, 130, 132 and 134, as well as two traffic lights with intersection cameras 140 and 142. Driven vehicle 132 is traveling in one direction while driven vehicles 10, 130 and 134 are traveling in an opposite direction. In this particular example, driven vehicle 10 is the connected vehicle described earlier and has been involved in an accident with driven vehicle 134 which is a non-connected vehicle. In addition, two pedestrians 150 and 152 and another driven vehicle 154 are crossing the intersection or are at least near the intersection at the time of the accident.

Vehicles 10, 114, 130, 132 and 154 are examples of connected vehicles that are capable of wirelessly sending and/or receiving cooperative perception messages (CPMs), whereas vehicles 110, 112 and 134 are examples of non-connected vehicles. Intersection cameras 120, 122, 140 and 142 are examples of connected infrastructure that can send and/or receive CPMs, however, other connected infrastructure could be used as well. For instance, intersection 100 may include any number of wireless transceivers or beacons that are built into the road, signs, bridges, overpasses, lights, toll booths, etc., all of which could be connected infrastructure. Pedestrians 150 and 152 may be sitting, standing, walking, riding a device such as a skateboard, scooter, bike, etc. or engaging in some other activity. Pedestrian 150 is an example of a non-connected pedestrian and pedestrian 152 is an example of a connected pedestrian, as this pedestrian has a smart phone or other device that wirelessly communicates on a common authenticated network.

A cloud-based backend system 170 may be provided that can wirelessly communicate with the various connected entities 10, 114, 130, 132, 154, 120, 122, 140, 142 and 152 via any suitable combination of a satellite-based communication network, a WiFi-based communication network, a cellular-based communication network 172 and/or other communication network. It should be appreciated that any suitable type of wireless communication network, system and/or technology may be employed to connect the various connected entities to the cloud-based backend system 170 and/or to each other, and that the present system and method are not limited to any particular type. Backend system 170 may include any suitable combination of software and/or hardware resources typically found in a backend of a cloud-based system, and is generally responsible for receiving and analyzing real-time information from one or more connected vehicles and/or other connected entities and for sending instructions and/or information to the connected vehicles. The backend system 170 is typically responsible for managing some of the programs and algorithms that run applications for the present system and method. The backend system 170 may be managed or controlled by the vehicle manufacturer and can be part of a larger cloud-based system that the vehicle manufacturer uses to communicate and interact with a large fleet of vehicles for a multitude of purposes, not just those encompassed by the present system and method.

The cloud-based backend system 170 may include any suitable combination of software and/or hardware resources including, but not limited to, components, devices, computers, modules and/or systems such as those directed to applications, service, storage, management and/or security (each of these resources is referred to herein as a “backend resource,” which broadly includes any such resource located at the backend system 170). In one example, the backend system 170 has a number of backend resources including data storage systems, servers, communication systems, programs and algorithms, as well as other suitable backend resources. It should be appreciated that backend system 170 is not limited to any particular architecture, infrastructure or combination of elements, and that any suitable backend arrangement may be employed.

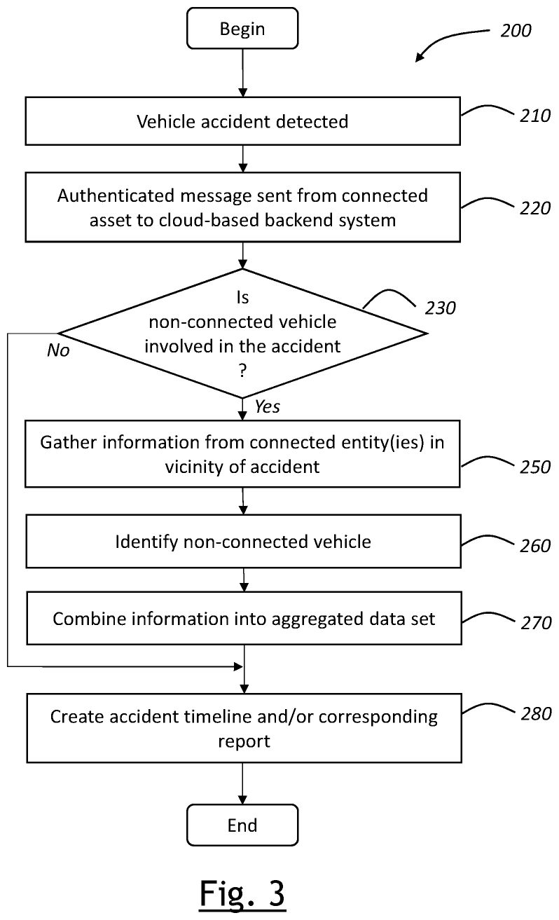

With reference to FIG. 3, there is shown an example of a cooperative detection method 200, where the method is described in conjunction with system 90, intersection 100 and the scenario illustrated in FIG. 2. According to this example, the method begins when a vehicle accident or collision is detected, step 210. There are many different ways in which the method may detect an accident, such as by evaluating accident information for evidence of a collision. This evaluation may occur at the connected vehicle 10, at the cloud-based backend system 170, at some other connected entity, or at a combination thereof. For example, airbag sensor 26 on connected vehicle 10 could gather accident information and send a corresponding message or signal to the collision detection control module 44 and/or the CPM control module 50 indicating that one or more airbags have been deployed, at which point accident detection could be performed at connected vehicle 10 or that information could be conveyed to backend facility 170 and/or another connected entity for accident detection. In different examples, an accident may be detected by evaluating accident information from one or more: sensor(s) 20-24, cameras 30-32, modules 40-52, other connected entities in the area (e.g., intersection cameras), or some other source. Once an accident is detected, the method may progress to the next step.

In step 220, an authenticated message with accident information may be sent from a connected entity to the cloud-based backend system. By sending this message, the cooperative detection system and method will be informed that an accident has occurred. Referring to the exemplary scenario illustrated in FIG. 2, if connected vehicle 10 detects the accident (e.g., if it was involved in the accident and captured it with its sensors and/or cameras), then the CPM control module 50 could cause the telematics control module 48 to send an authenticated message (e.g., a cooperative perception message (CPM)) to cloud-based backend system 170 via communication network 172, where the CPM includes various types of accident information. The term “accident information,” as used herein, broadly includes any type of electronic data, images, video, readings, messages, signals and/or other electronic information that pertains to an accident, to a vehicle involved in an accident, to the circumstances or causes of an accident and/or to the road or area surrounding an accident, as well as information that is derived therefrom or representative thereof. Some non-limiting examples of accident information include: internal sensor data from sensors 20-26; images and video from cameras 30-32; messages and information from modules 40-52; external sensor data, images and/or video from other connected vehicle(s) in the vicinity of the accident; external sensor data, images and/or video from connected infrastructure in the vicinity; and external sensor data, images and/or video from connected pedestrian(s) in the vicinity. The authenticated message of step 220 could be sent as part of the accident detection process in step 210 or as a separate step.

Next, the method may determine if any non-connected vehicles were involved in the accident, step 230. Again, this determination may be carried out at the connected vehicle 10, at the cloud-based backend system 170, at another connected entity or at a combination thereof. According to one example, step 230 evaluates the accident information included in the authenticated message of step 220 to determine if one or more vehicle(s), other than vehicle 10, were involved in the accident. It is also possible for step 230 to gather external sensor data from other connected entities in the area, such as connected vehicles 114, 130, 132, 154, connected infrastructure 120, 122, 140, 142, connected pedestrian 152, etc., and to use this information to decide if any other vehicles were involved in the accident. It could be that connected vehicle 10 crashed into a guardrail, tree, sign post, or some other object such that no other vehicles were involved, which is why step 230 tries to ascertain the connected status of other vehicle(s) in the vicinity of the accident. If other vehicle(s) appear to be involved, step 230 may determine if such vehicle(s) are “connected vehicles” by checking to see if they have sent any messages regarding the accident and/or by attempting to directly contact such vehicle(s) on the same authenticated network as used to communicate with connected vehicle 10.

If step 230 determines that there are no non-connected vehicles involved in the detected collision, then the method proceeds to step 280, which is described later; if it is determined that one or more non-connected vehicle(s) are involved, then the method proceeds to step 250. In the exemplary scenario of FIG. 2, a non-connected vehicle 134 is involved in the accident, thus, the method proceeds to step 250.

In step 250, the method attempts to gather various pieces of information from different connected entities in the vicinity of the accident in an effort to better understand the situation and circumstances leading up to the crash. This step may be carried out in a variety of different ways at the connected vehicle 10, at the cloud-based backend system 170, at another connected entity or at a combination thereof. According to one example, which is provided in the context of the scenario in FIG. 2, step 250 first establishes an area of interest 180 that is within a specified radius or distance of the detected vehicle accident and then attempts to gather accident information from any connected entities within that area. Area of interest 180 may be established by first identifying the location of the vehicle accident involving vehicles 10 and 134 and then setting a perimeter around that location (e.g., the perimeter may be 100 m, 50 m, 25 m, 10 m, etc. from the spot of the accident). The perimeter or size of the area of interest may be inversely proportional to the density of connected entities in that area (e.g., if the accident occurs in a densely populated urban setting with lots of connected entities nearby, then a smaller area of interest could be used; if the accident occurs in a sparsely populated rural area, then the area of interest may need to be enlarged in order to obtain sufficient data). The perimeter or size of the area of interest may also be impacted by the size of the accident scene (e.g., if crashed vehicles and/or debris are spread over a large area, then a larger area of interest could be established). In other examples, the area of interest may be established by identifying the intersection 100 or sections of first and second roads 102, 104 leading up to the intersection, or by other techniques.

Once the area of interest 180 is established, step 250 may attempt to gather relevant accident information and/or other information from the connected entities within that area. For example, there are quite a few potential sources of useful information within area of interest 180, however, not all of them are “connected” entities and not all of them have useful information. Vehicles 10, 112, 132, 134 and 154 are all located within area of interest 180, but only vehicles 10, 132 and 154 are “connected” vehicles capable of wirelessly providing information via authenticated messages, such as cooperative perception messages (CPMs). Furthermore, vehicle 154 may be a “connected” vehicle, but due to it turning onto first road 102 at the time of the accident, it may not be in a position to provide any useful information. A similar situation exits with the connected infrastructure, as intersection cameras 120, 122, 140 and 142 are all within the area of interest 180, but due to their respective orientations and fields-of-view, only cameras 140 and 142 may be able to provide useful information pertaining to non-connected vehicle 134. Skilled artisans will appreciate that connected intersection or traffic cameras oftentimes keep track of which vehicles are approaching and at which speeds. Pedestrian 150 is a non-connected pedestrian and is, thus, unable to wirelessly provide information, whereas pedestrian 152 is connected and may be in a position to contribute useful information to the recreation process.

Step 250 attempts to gather as much data and information as possible in order to recreate the movements and dynamics of the non-connected vehicle 134 leading up to the crash and, by doing so, gain a better situational awareness of the surrounding area in the moments leading up to the crash. The information gathered in step 250 may have been sent from the connected entity that generated it to the cloud-based backend system 170 via one or more authenticated messages (e.g., cooperative perception messages (CPMs)) that are sent on a regular basis. To explain, each of the connected entities in cooperative detection system 90 may be configured so that they are continually gathering internal and/or external data and reporting that information to backend system 170 via CPMs at regular intervals. This process of continual monitoring and reporting can occur under normal conditions, even without the detection of any vehicle accidents, and provides a wealth of historical or past data that can be useful to future accident investigations, if needed.

Step 260 may use much of the same accident information gathered in the previous step and attempts to identify the non-connected vehicle(s) involved in the accident. This step may also be carried out at the connected vehicle 10, at the cloud-based backend system 170, at another connected entity or at a combination thereof, and it may be executed before, after, or concurrently with the previous step. According to one example, step 260 evaluates any images or video acquired from the connected entities within the area of interest in an effort to recognize license plate characters and/or other indicia (e.g., signage on the side of the vehicle) that could identify the non-connected vehicle 134. If such indicia is recognized, the method could attempt to look up the corresponding driver and/or vehicle information in public record databases or the like. Step 260, as well as the other steps described herein, may use various artificial intelligence (AI) tools and can be repeated for each non-connected vehicle involved in the vehicle accident.

Next, the method may combine the information gathered in the previous steps into an aggregated data set, step 270. By combining or pooling the various pieces of previously gathered information into a single aggregated data set, the method is able to collect large amounts of potentially relevant information from different connected entities, filter out duplicative information and/or information that is otherwise not useful, and then present the refined collection of information in a condensed and organized way so that it can help recreate the scene or circumstances leading up to the accident. In addition to accident information acquired in steps 210-250, the aggregated data set may also include identification information gathered in step 260, historical data periodically reported from connected entities in cooperative perception messages (CPMs) and/or recreations of the movements of the non-connected vehicle(s) and/or the circumstances leading up to and potentially causing the crash. The identification information and/or history data may constitute a type of accident information, as explained above.

Step 280 can then create an accident timeline that extends over a certain period of time and involves the connected and non-connected vehicle(s) involved in the vehicle accident. According to one example, the accident timeline begins at a starting point that is before the occurrence of the vehicle accident (e.g., 30 seconds, 10 seconds, 5 seconds, etc. before the accident) and extends to an ending point that is at or after the vehicle accident (e.g., 30 seconds, 10 seconds, 5 seconds, 0 seconds, etc. after the accident). The exact length and duration of the accident timeline could vary depending on the nature, severity and/or location of the accident, as well as on the number of vehicles involved. In terms of its contents, the accident timeline could pertain to a certain vehicle only (e.g., the non-connected vehicle 134), to all of the vehicles involved in the accident, to all of the vehicles and/or connected entities that were in the area of interest 180 at some point during the accident timeline, etc. The accident timeline can then be presented or otherwise made available to properly authorized authorities who are investigating the accident. It is also possible to adjust the starting point, ending point and/or duration of the accident timeline, as well as the size and shape of the area of interest such that a new report and timeline can be generated. If, for example, the content of the accident timeline and report is deemed insufficient, it is possible to adjust the starting point and go back farther in time and/or to enlarge the area of interest so that more data and information is included. Other ways of adjusting or customizing the accident timeline and corresponding reports are also possible.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A cooperative detection method for use with vehicles, comprising the steps of:
detecting a vehicle accident;
determining that a non-connected vehicle was involved in the vehicle accident;
receiving accident information from at least one connected entity in the vicinity of the vehicle accident;
combining accident information into an aggregated data set; and
using the aggregated data set to generate an accident report, wherein the accident report includes information pertaining to the non-connected vehicle.

2. The cooperative detection method of claim 1, wherein the detecting step further comprises: gathering accident information with one or more vehicle sensor(s) and/or vehicle camera(s) mounted on a connected vehicle that was involved in the vehicle accident, providing the accident information from the vehicle sensor(s) and/or the vehicle camera(s) to a control module mounted on the connected vehicle, evaluating the accident information at the control module and detecting the vehicle accident, and sending a wireless message or signal from the connected vehicle to a cloud-based backend system indicating that the vehicle accident has been detected.

3. The cooperative detection method of claim 1, wherein the detecting step further comprises: gathering accident information with one or more vehicle sensor(s) and/or vehicle camera(s) mounted on a connected vehicle that was involved in the vehicle accident, providing the accident information from the vehicle sensor(s) and/or the vehicle camera(s) to a control module mounted on the connected vehicle, sending a wireless message or signal that includes the accident information from the connected vehicle to a cloud-based backend system, and evaluating the accident information at the cloud-based backend system and detecting the vehicle accident.

4. The cooperative detection method of claim 1, wherein the detecting step further comprises: gathering accident information with one or more sensor(s) and/or camera(s) mounted on a connected entity that was not involved in the vehicle accident but was in the vicinity of the vehicle accident, sending a message or signal that includes the accident information from the connected entity to a cloud-based backend system, and evaluating the accident information at the cloud-based backend system and detecting the vehicle accident.

5. The cooperative detection method of claim 1, wherein the determining step further comprises: evaluating accident information at a control module mounted on a connected vehicle that was involved in the vehicle accident, deciding if any other vehicles were involved in the vehicle accident, when one or more other vehicle(s) were involved, then attempting to establish direct communication between the connected vehicle and the other vehicle(s) to ascertain their connected status, and determining that a non-connected vehicle was involved in the vehicle accident based on its connected status.

6. The cooperative detection method of claim 1, wherein the determining step further comprises: evaluating accident information at a cloud-based backend system, deciding if any other vehicles were involved in the vehicle accident, when one or more other vehicle(s) were involved, then checking the status of all vehicles in the vicinity of the vehicle accident to ascertain their connected status, and determining that a non-connected vehicle was involved in the vehicle accident based on its connected status.

7. The cooperative detection method of claim 1, wherein the receiving step further comprises: identifying a location of the vehicle accident, establishing an area of interest that includes the location of the vehicle accident, and receiving accident information from at least one connected entity within the area of interest.

8. The cooperative detection method of claim 7, wherein the area of interest is established by defining a perimeter around the location of the vehicle accident.

9. The cooperative detection method of 8, wherein a size of the area of interest is inversely proportional to the density of connected entities located within the area of interest.

10. The cooperative detection method of claim 7, wherein the area of interest is established by identifying an intersection or section of road that includes the location of the vehicle accident.

11. The cooperative detection method of claim 1, wherein the receiving step further comprises receiving a wireless cooperative perception message (CPM) that includes the accident information from a connected vehicle.

12. The cooperative detection method of claim 1, wherein the receiving step further comprises receiving a cooperative perception message (CPM) that includes the accident information from a piece of connected infrastructure.

13. The cooperative detection method of claim 1, wherein the receiving step further comprises receiving a wireless cooperative perception message (CPM) that includes the accident information from a connected pedestrian.

14. The cooperative detection method of claim 1, further comprising the step of:
after the receiving step, evaluating images or video that was included with the accident information in order to recognize license plate characters and/or other indicia and to identify the non-connected vehicle.

15. The cooperative detection method of claim 1, wherein the combining step further comprises: collecting accident information that was previously acquired, filtering out accident information that is duplicative and/or otherwise not useful, and presenting the filtered accident information in a report that can assist authorities investigating the vehicle accident.

16. The cooperative detection method of claim 15, wherein the report includes identification information that identifies the non-connected vehicle involved in the vehicle accident.

17. The cooperative detection method of claim 1, wherein the using step further comprises: establishing an accident timeline that extends from a starting point before the vehicle accident to an ending point at or after the vehicle accident, establishing an area of interest that encompasses the location of the vehicle accident, using the aggregated data set to generate the accident report with the accident timeline, wherein the accident timeline includes information pertaining to a plurality of vehicles that were located within the area of interest at some point during the accident timeline.

18. The cooperative detection method of claim 17, wherein the starting point and/or the ending point can be adjusted to change the duration of the accident timeline.

19. The cooperative detection method of claim 17, wherein the area of interest can be adjusted to change the size of the area encompassed by the accident timeline.

20. A cooperative detection system for use with vehicles, comprising:
a plurality of connected vehicles, each of the connected vehicles is configured to detect a vehicle accident; and
a cloud-based backend system, the cloud-based backend system is in wireless communication with the plurality of connected vehicles and is configured to: determine if a non-connected vehicle was involved in the vehicle accident detected by one of the connected vehicles, receive accident information from at least one connected entity in the vicinity of the vehicle accident; combine accident information into an aggregated data set; and use the aggregated data set to generate an accident report, wherein the accident report includes information pertaining to the non-connected vehicle.
